(19) United States
(12) Patent Application Publication
(10) Pub. No.: US 2011/0109525 A1
(43) Pub. Date: May 12, 2011

(54) Antenna device and wireless communication apparatus having the same

(75) Inventors: Nobuyasu Takemura, Yokohama-shi (JP); Minoru Hasegawa, Yokohama-shi (JP)

(73) Assignee: SAMSUNG ELECTRONICS CO., LTD., Suwon-si (KR)

(21) Appl. No.: 12/927,350

(22) Filed: Nov. 12, 2010

(30) Foreign Application Priority Data
Nov. 12, 2009 (JP) 2009-258646
Nov. 12, 2009 (JP) 2009-258647
Sep. 17, 2010 (KR) 10-2010-0091687

(51) Int. Cl. H01Q 3/24

(52) U.S. Cl. 343/904

(57) ABSTRACT

An antenna device includes a dielectric that has a first and a second substantially planar surfaces facing in substantially opposite directions. An inverted-L antenna is disposed at a side of the dielectric. A first conductive member forms a first loop that has a first gap. A planar side of the first loop is disposed facing the first substantially planar surface of the dielectric. A second conductive member forms a second loop that has a second gap. A planar side of the second loop is disposed facing the second substantially planar surface of the dielectric. Each of the first and second conductive members includes a plurality of member components and a plurality of switches, and each of the plurality of switches are provided between two adjacent member components to allow the plurality of member components to be electrically conducted or cut off.

### CROSS-REFERENCE TO RELATED APPLICATION(S) AND CLAIM OF PRIORITY

The present application is related to and claims the priority under 35 U.S.C. §119(a) of applications entitled “Antenna Device And Wireless Communication Apparatus Having The Same” filed in Japanese Patent Office on Nov. 12, 2009 and assigned Serial No. 2009-258646, Nov. 12, 2009 and assigned Serial No. 2009-258647, and filed in Korean Intellectual Property Office on Sep. 17, 2010 and assigned Serial No. 10-2010-0091687, the contents of which are hereby incorporated by reference.

### TECHNICAL FIELD OF THE INVENTION

The present invention relates to an antenna device and a wireless communication apparatus having the same and, more particularly, to an antenna device used for a mobile communication terminal and a wireless communication apparatus having the same.

### BACKGROUND OF THE INVENTION

A current wireless communication apparatus has a wireless communication function that corresponds to a plurality of wireless communication systems, and a small-sized antenna or an antenna that operates in a plurality of frequency bands or a wide range is required.

In an antenna device that operates in a plurality of frequency bands, a tunable antenna changes a frequency band. For example, in International Publication pamphlet No. 07/042,615, an adjustment circuit obtained by combining conductive lines with different lengths is installed at a power supply part of a monopole antenna, resulting in an antenna device that changes a frequency band. Furthermore, in JP-T-2009-510900, a selection circuit connected to a parasitic element of an antenna device is switched to change capacitive coupling with a monopole antenna, resulting in a change in a resonant frequency. In addition, an attempt has been made to achieve an antenna that operates in a wide band by using a SRR (Split Ring Resonator). Because the SRR has been known as an element of a meta-material and is a structure that exhibits material characteristics (negative permeability) that do not exist naturally, research has been conducted in order to obtain a magnetic response at a desired frequency. For example, in U.S. Pat. No. 6,970,137, wide band characteristics are achieved using a PIFA (Planar Inverted-F Antenna) obtained by inserting a dielectric including a plurality of SRRs therein between a ground conductor and an antenna conductor.

### SUMMARY OF THE INVENTION

In the tunable antenna according to the conventional art, the conductive lines with the different lengths are switched using a switch, resulting in a change in a frequency band. However, conductive lines are required corresponding to the number of variable frequency bands. Therefore, when the number of variable frequency bands increases, because the structure of the antenna is increased, the antenna may not be fabricated in a small size. Furthermore, even when the selection circuit is connected to the parasitic element and switched using a switch, resulting in a change in a frequency band, when the number of variable frequency bands increases, because it is necessary to increase the number of parasitic elements, the antenna may not be fabricated in a small size due to the increase in the structure of the antenna.

To address the above-discussed deficiencies of the prior art, it is a primary object to provide an antenna device that can be fabricated in a small size without the increase in the structure thereof even if the number of frequency bands used increases, and can easily change a resonant frequency in a desired frequency band.

Also, in U.S. Pat. No. 6,970,137, because the plurality of SRRs are disposed in the dielectric block constituting the antenna, the structure thereof is complicated and the dielectric block may not be easily manufactured. Furthermore, because the plurality of SRRs are disposed in the dielectric block, it is difficult to adjust the length of each SRR, an interval among the SRRs and the like, and cost may increase in order to manufacture an antenna with desired performance. In addition, the SRR operates at a frequency at which the length of a conductor is close to half the wavelength. Therefore, when determining the material characteristics of the dielectric block or the dimensions of the SRR in the antenna configuration disclosed in U.S. Pat. No. 6,970,137, the SRR may not operate in a desired frequency band.

Accordingly, the present invention has been made to solve the above-mentioned problems occurring in the prior art, and the present invention provides an antenna device and a wireless communication apparatus that can be fabricated in a small size by using material characteristics around the resonant frequency of the SRR, and can operate in a desired frequency band.

In accordance with an aspect of the present invention, an antenna device includes a dielectric that has a first and a second surfaces facing in substantially opposite directions. An inverted-L antenna is disposed at a side of the dielectric. A first conductive member forms a first loop that has a first gap. A planar side of the first loop is disposed facing the first surface of the dielectric. A second conductive member forms a second loop that has a second gap. A planar side of the second loop is disposed facing the second substantially planar surface of the dielectric. Each of the first and second conductive members includes a plurality of member components and a plurality of switches. And each of the plurality of switches are provided between two adjacent member components to allow the plurality of member components to be electrically conducted or cut off. According to the antenna device, in accordance with an embodiment of the present invention, a resonant frequency may be easily changed in a desired frequency band.

Furthermore, in the antenna device in accordance with an embodiment of the present invention, each of the first and second gaps may form an opening in the first and second loops of the first and second conductive members, respectively. A length of each of the first and second conductive members may form an inductance component. A size of the opening may form a capacitance component. The first and second conductive members may form an LC resonance circuit including the inductance component and the capacitance component. And the plurality of switches may allow the plurality of member components to be electrically conducted or cut off through an ON/OFF operation to change a number of connections, through which the plurality of member components are connected to each other, for each conductive member, resulting in a change in the inductance component of the first and second conductive members. According to the antenna device in accordance with an embodiment of the present invention, the antenna device may operate in a desired frequency band.

Furthermore, the antenna device in accordance with an embodiment of the present invention may further include a control unit that controls the ON/OFF operation of each switch according to a wireless communication frequency band used to change the inductance component of the first and second conductive members. The control unit may detect a frequency of a wireless communication signal and control the ON/OFF operation of each switch according to the detected frequency. According to the antenna device in accordance with an embodiment of the present invention, the antenna device may be automatically shifted to a desired frequency band.

Furthermore, in the antenna device in accordance with an embodiment of the present invention, the plurality of switches may allow the plurality of member components to be electrically conducted or cut off. According to the antenna device in accordance with an embodiment of the present invention, the ON/OFF operation of each switch may be performed at a high speed, and noise may be reduced.

Furthermore, in the antenna device, in accordance with an embodiment of the present invention, the first conductive member may be bonded to the first surface, and the second conductive member is bonded to the second surface of the dielectric. According to the antenna device in accordance with an embodiment of the present invention, the antenna device may easily adapt with design modification.

Furthermore, in the antenna device in accordance with an embodiment of the present invention, the first and second conductive members may be formed on the first and second surfaces of the dielectric, respectively, by using an etching method. According to the antenna device in accordance with an embodiment of the present invention, the antenna device may easily adapt with design modification.

Furthermore, in the antenna device in accordance with an embodiment of the present invention, the dielectric may have a thin plate shape. According to the antenna device in accordance with an embodiment of the present invention, the antenna device may be easily mounted in a wireless communication apparatus and such.

A wireless communication apparatus in accordance with an embodiment of the present invention includes the above-described antenna device. The wireless communication apparatus, in accordance with an embodiment of the present invention, may easily adapt with various communication schemes.

In accordance with an aspect of the present invention, an antenna device includes a dielectric that includes a first and a second surfaces facing in substantially opposite directions. An inverted-L antenna may be disposed at a side of the dielectric. A first conductive member may form a first loop that has a first gap. A planar side of the first loop may be disposed facing the first surface of the dielectric. A second conductive member may form a second loop that has a second gap. A planar side of the second loop may be disposed facing the second surface of the dielectric. According to the antenna device in accordance with an embodiment of the present invention, it may be possible to achieve a wavelength shortening effect which is larger than a wavelength shortening effect due to the material constant.

Furthermore, in the antenna device in accordance with an embodiment of the present invention, each of the first and second gaps may form an opening in the first and second loops of the first and second conductive members, respectively. A length of each of the first and second conductive members may form an inductance component. A size of the opening may form a capacitance component. The plurality of conductive members may form an LC resonance circuit including the inductance component and the capacitance component. And at least one of the length of each of the first and second conductive members and the size of the opening may be adjusted to control a resonant frequency of the LC resonance circuit. According to the antenna device in accordance with an embodiment of the present invention, it may be possible to easily achieve wide band characteristics by which an operation in a desired frequency band is possible.

Furthermore, in the antenna device in accordance with an embodiment of the present invention, relative positions of the first and second conductive members disposed facing the dielectric may be changed to control the capacitance component. According to the antenna device in accordance with an embodiment of the present invention, it may be possible to easily achieve wide band characteristics by which an operation in a desired frequency band is possible.

Furthermore, in the antenna device in accordance with an embodiment of the present invention, a relative distance between the first and second conductive members may be changed according to thickness of the dielectric to control the capacitance component. According to the antenna device in accordance with an embodiment of the present invention, it may be possible to easily achieve wide band characteristics by which an operation in a desired frequency band is possible.

Furthermore, in the antenna device in accordance with an embodiment of the present invention, relative positions of the first and second conductive members disposed facing the dielectric and the inverted-L antenna may be changed to control the capacitance component. According to the antenna device in accordance with an embodiment of the present invention, it may be possible to easily achieve wide band characteristics by which an operation in a desired frequency band is possible.

Furthermore, in the antenna device in accordance with an embodiment of the present invention, a length of each of the first and second conductive members disposed facing the dielectric and a length of the inverted-L antenna are changed to control the inductance component. According to the antenna device in accordance with an embodiment of the present invention, it may be possible to easily achieve wide band characteristics by which an operation in a desired frequency band is possible.

Furthermore, in the antenna device in accordance with an embodiment of the present invention, the first and second conductive members may be formed on the first and second surfaces of the dielectric by using an etching method. According to the antenna device in accordance with an embodiment of the present invention, the antenna device may easily cope with design modification.

Furthermore, in the antenna device in accordance with an embodiment of the present invention, the first and second conductive members are bonded to the first and second surfaces of the dielectric, respectively. According to the antenna device in accordance with an embodiment of the present invention, the antenna device may easily cope with design modification.

Furthermore, in the antenna device in accordance with an embodiment of the present invention, the dielectric may have a thin plate shape. According to the antenna device in accordance with an embodiment of the present invention, the antenna device may be easily mounted in a wireless communication apparatus and such.

A wireless communication apparatus in accordance with an embodiment of the present invention includes the above-described antenna device. The wireless communication apparatus in accordance with an embodiment of the present invention may easily adapt with various communication schemes.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a plan view that illustrates the outline of an antenna device in accordance with an embodiment of the present invention;

FIG. 2 illustrates a perspective view of an entire configuration of an antenna device in accordance with an embodiment of the present invention;

FIGS. 3A and 3B illustrates plan views of a configuration example of SRRs of an antenna device in accordance with an embodiment of the present invention, wherein FIG. 3A illustrates plan view of the configuration example of a SRR formed on the front surface of a dielectric, and FIG. 3B illustrates a plan view of the configuration example of a second SRR formed on the rear surface of the dielectric;

FIG. 4 illustrates permittivity characteristics of the antenna device illustrated in FIG. 2;

FIG. 5 illustrates permeability characteristics of the antenna device illustrated in FIG. 2;

FIG. 6 illustrates the circuit configuration of a wireless communication apparatus provided with an antenna device in accordance with an embodiment of the present invention;

FIG. 7 illustrates an example of VSWR frequency characteristics when a LTE frequency band of the antenna device illustrated in FIG. 2 is changed;

FIG. 8 illustrates an example of VSWR frequency characteristics when a GSM frequency band of the antenna device illustrated in FIG. 2 is changed;

FIGS. 9A to 9C illustrate plan views of other shapes of a SRR of an antenna device in accordance with an embodiment of the present invention, wherein FIG. 9A illustrates a plan view of the shape of a SRR with an opening formed by removing a part of a polygonal shape, and FIG. 9B illustrates a diagram of the shape of a SRR with an opening formed by removing a part of a rectangular shape, and FIG. 9C illustrates a diagram of the shape of a SRR with an opening formed by removing a part of a ring shape;

FIG. 10 illustrates a perspective view of the configuration of main elements of an antenna device in accordance with an embodiment of the present invention;

FIG. 11 illustrates a perspective view of the entire configuration of an antenna device in accordance with an embodiment of the present invention;

FIG. 12 illustrates a diagram of permittivity characteristics of the antenna device illustrated in FIG. 10;

FIG. 13 illustrates a diagram of permeability characteristics of the antenna device illustrated in FIG. 10;

FIG. 14 illustrates a diagram of VSWR frequency characteristics of the antenna device illustrated in FIG. 10;

FIG. 15 illustrates a perspective view of the entire configuration of an antenna device in accordance with an embodiment of the present invention;

FIGS. 16A to 16C illustrate plan views of other shapes of a SRR of an antenna device in accordance with an embodiment of the present invention, wherein FIG. 16A illustrates the shape of a SRR with an opening formed by removing a part of a polygonal shape, and FIG. 16B illustrates the shape of a SRR with an opening formed by removing a part of a rectangular shape, and FIG. 16C illustrates the shape of a SRR with an opening formed by removing a part of a ring shape; and

FIG. 17 schematically illustrates the configuration of a wireless communication apparatus provided with an antenna device in accordance with an embodiment of the present invention.

### DETAILED DESCRIPTION OF THE INVENTION

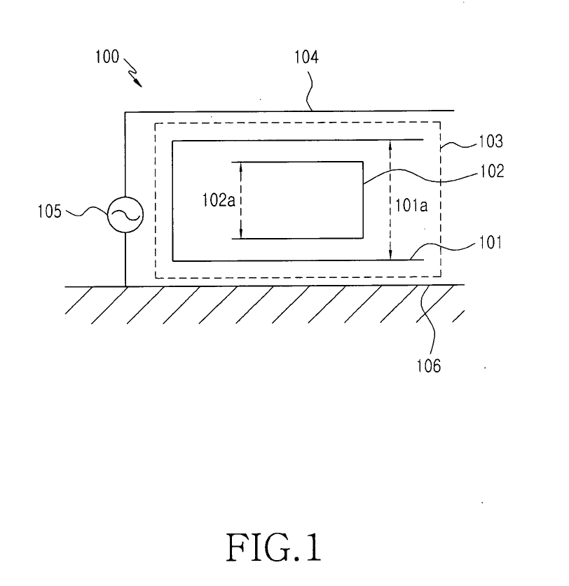

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication device. Furthermore, various specific definitions found in the following description are provided only to help the general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

FIG. 1 illustrates a plan view of the outline of an antenna device in accordance with an embodiment of the present invention. The object of the antenna device in accordance with the embodiment of the present invention is to dispose a switch on a conductor constituting a SRR (Split Ring Resonator) by using material characteristics around the resonant frequency of the SRR and to turn on/off the switch, resulting in the miniaturization of the antenna device and a change in the resonant frequency of a desired frequency band. The SRR is a structure that includes a metal (a conductive member) in which at least a part thereof is separated, and produces the characteristics of the SRR, which will be described later.

The antenna device 100 illustrated in FIG. 1 includes a first SRR 101, a second SRR 102, a dielectric 103, an element conductor 104, a power supply point 105, and a ground conductor 106. The element conductor 104 has an inverted-L shape and constitutes an inverted-L antenna. Furthermore, the element conductor 104 is connected to the ground conductor 106 through the power supply point 105 and the dielectric 103 is disposed between the ground conductor 106 and the element conductor 104. The dielectric 103 may have a thin plate shape, and the first SRR 101 and the second SRR 102 are disposed facing one surface and another surface of the dielectric 103, respectively. Each of the first SRR 101 and the second SRR 102 is a structure that includes a metal (a conductive member) in which at least a part thereof is separated, and produces the characteristics of the SRR, which will be described later.

The first SRR 101 and the second SRR 102 have a first opening 101a and a second opening 102a, which are formed by removing a part of a rectangle, respectively. However, the present invention is not limited to the rectangle. For example, the first SRR 101 and the second SRR 102 may also have a shape which is formed by removing at least a part of a polygonal or ring shape. The first SRR 101 and the second SRR 102 are disposed at opposite sides with the dielectric 103 interposed between them while they are misaligned from each other. For example, when the first opening 101a of the first SRR 101 is located at a right side of the dielectric 103, the second opening 102a of the second SRR 102 is located at a left side of the dielectric 103. Furthermore, the first SRR 101 and the second SRR 102 may have the same shape or different shapes from each other.

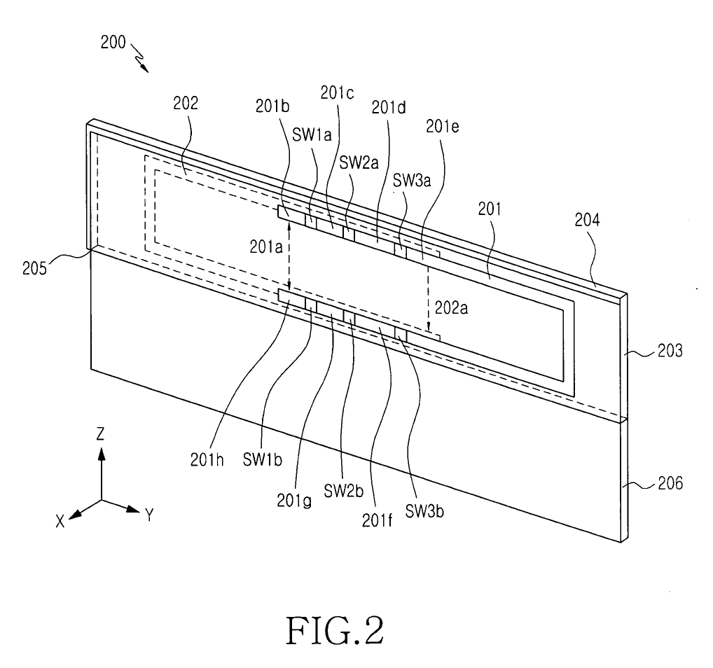

FIG. 2 illustrates a perspective view of an entire configuration of an antenna device in accordance with an embodiment of the present invention. A dielectric 203 of the antenna device 200 has a rectangular thin plate shape, and a first SRR 201 and a second SRR 202 are disposed on the front surface and the rear surface of the dielectric 203, respectively. As illustrated in FIG. 2, the first SRR 201 and the second SRR 202 have a first opening 201a and a second opening 202a, which are formed by removing one side of a rectangle, respectively. The first SRR 201 and the second SRR 202 have the same shape and are disposed at opposite sides with the dielectric 103 interposed between them.

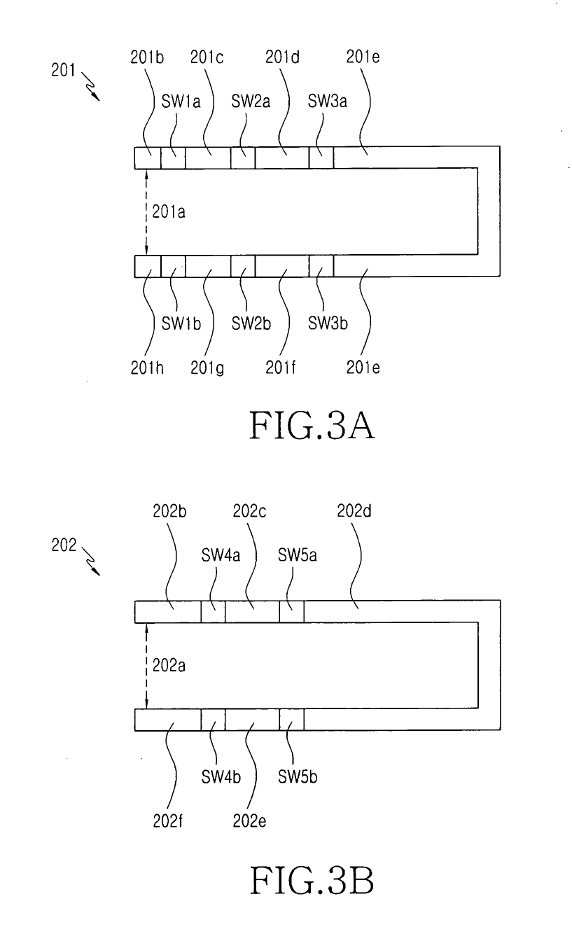

FIGS. 3A and 3B illustrate plan views of a configuration example of the first SRR 201 and the second SRR 202 of the antenna device 200 illustrated in FIG. 2, wherein FIG. 3A illustrates a plan view of the configuration example of the first SRR 201 formed on the front surface of the dielectric 203, and FIG. 3B illustrates a plan view of the configuration example of the second SRR 202 formed on the rear surface of the dielectric 203.

As illustrated in FIGS. 2 and 3, the first SRR 201 and the second SRR 202 include a plurality of switches disposed on conductors constituting the first SRR 201 and the second SRR 202, respectively. The switches in accordance with the embodiment of the present invention, for example, may be formed of a switch such as a MEMS switch or a relay, or a variable capacitor element such as a varicap diode. Furthermore, the switches in accordance with the embodiment of the present invention allow the conductors to be mechanically or electrically conducted or cut off at portions, at which the switches are disposed in the first SRR 201 and the second SRR 202, through a switching ON/OFF operation. With respect to the switches for allowing the conductors to be electrically conducted or cut off, the switching ON/OFF operation can be performed at a high speed and noise can be reduced. The operation and circuit configuration of the switch, in accordance with the embodiment of the present invention, will be described in detail later.

In accordance with the embodiment of the present invention, as illustrated in FIG. 3A, the first SRR 201 includes a plurality of members 201b to 201h, a switch SW1a is disposed between the members 201b and 201c, a switch SW2a is disposed between the members 201c and 201d, a switch SW3a is disposed between the members 201d and 201e, a switch SW3b is disposed between the members 201e and 201f, a switch SW2b is disposed between the members 201f and 201g, and a switch SW1b is disposed between the members 201g and 201h. The six switches SW1a, SW1b, SW2a, SW2b, SW3a and SW3b allow the plurality of members 201b to 201h to be conducted or cut off through the switching ON/OFF operation, and change the number of connections among the members.

Furthermore, in accordance with the embodiment of the present invention, as illustrated in FIG. 3B, the second SRR 202 includes a plurality of members 202b to 202f, a switch SW4a is disposed between the members 202b and 202c, a switch SW5a is disposed between the members 202c and 202d, a switch SW5b is disposed between the members 202d and 202e, and a switch SW4b is disposed between the members 202e and 202f. The four switches SW4a, SW4b, SW5a and SW5b allow the plurality of members 202b to 202f to be conducted or cut off through the switching ON/OFF operation, and change the number of connections among the members.

In addition, in accordance with the embodiment of the present invention, as illustrated in FIGS. 3A and 3B, on the two linear conductors extending in the Y direction of the first SRR 201, the switch SW1b may be disposed facing the switch SW1a, the switch SW2b may be disposed facing the switch SW2a, and the switch SW3b may be disposed facing the switch SW3a. On the two linear conductors extending in the Y direction of the second SRR 202, the switch SW4b may be disposed facing the switch SW4a and the switch SW5b may be disposed facing the switch SW5a. Moreover, in accordance with the embodiment of the present invention, the number and positions of switches to be disposed may be appropriately changed according to the specifications thereof.

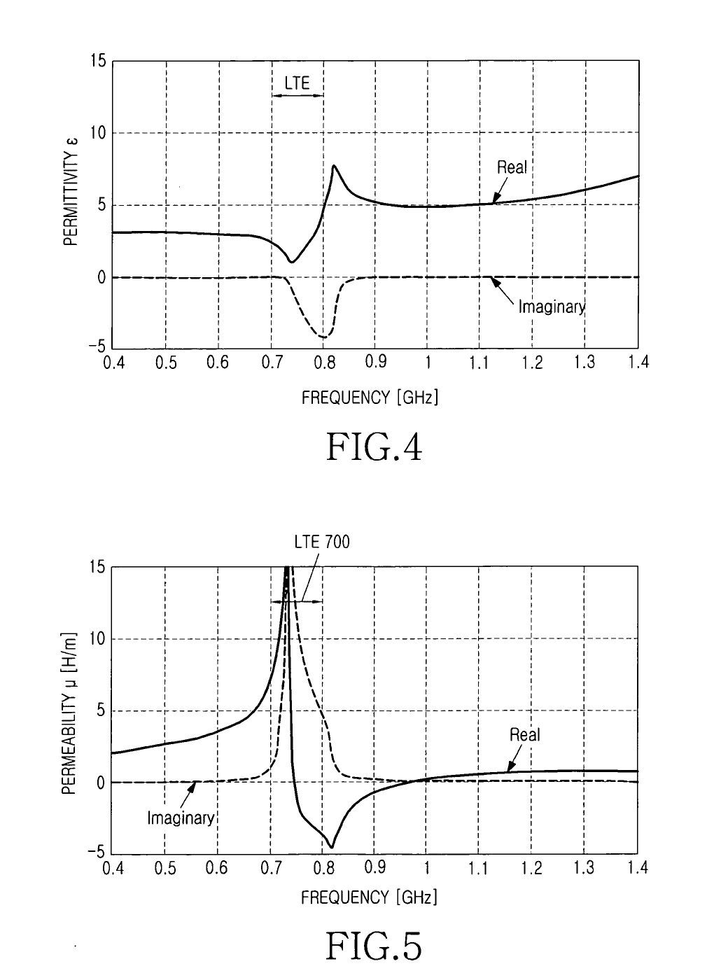

Next, the characteristics of the antenna device in accordance with the embodiment of the present invention will be described with reference to FIGS. 4 and 5. FIG. 4 illustrates a diagram of permittivity characteristics of the antenna device 200 illustrated in FIG. 2, and FIG. 5 illustrates a diagram of permeability characteristics of the antenna device 200 illustrated in FIG. 2. FIGS. 4 and 5 illustrate characteristics of real parts and imaginary parts of permittivity and permeability, respectively. Hereinafter, the general characteristics of the SRR regarding such characteristics will be described.

Characteristics of SRR

In general, the SRR includes two concentric circular metal rings that include “Splits” formed on a part thereof. This is a metal structure called a “double ring SRR” and this one element operates as an artificial atom showing a magnetic response. In this structure, an inductance component L may be provided at a ring part and a capacitance component C may be provided between the two rings. If electromagnetic waves (incident magnetic field) with a magnetic field component perpendicular to a plane including the rings are incident, an induction current J producing a resistance magnetic field opposing the incident magnetic field is induced on the rings according to the principle of magnetic field induction. Because the induction current flows along the rings but is cut off by the splits installed at a part of the rings, positive charge and negative charge with the same amount are accumulated between the inner and outer rings. The charges flow from the inner ring to the outer ring (or from the outer ring to the inner ring) through the capacitance between the rings, such that an LC resonance closed circuit is formed in the structure of the double ring SRR. At this time, the resonant frequency of the SRR is expressed by Equation 1 below using C and L of the structure.

$${f}_{0} = \frac{1}{2 π \sqrt{CL}} \qquad [ Eqn . 1 ]$$

A large induction current is induced around the resonant frequency and a larger resistance magnetic field is generated, resulting in a significant change in macro-permeability of the meta-material including the SRR. If electromagnetic waves with a frequency near the resonant frequency is incident, the electromagnetic waves are resonantly absorbed in the SRR. At this time, the imaginary part of the permeability corresponding to the absorption is increased and simultaneously the real part of the permeability is also changed. Variation of the real part is increased as variation of the imaginary part becomes larger, that is, as the Q value of the SRR becomes larger. If proper conditions are established, negative permeability may be achieved toward a high frequency side of the resonant frequency.

According to the SRR as described above, the magnetic-driving LC resonance circuit operates according to the operation principle thereof, and it is possible to produce a meta-material that exhibits a magnetic response at a desired operation frequency according to the design of a resonator.

Next, detailed characteristics of the antenna device using the characteristics of the above-described SRR in accordance with the embodiment of the present invention will be described.

The antenna device 200 illustrated in FIGS. 2 and 3 is formed using the characteristics of the SRR. For example, the antenna device 200 has the permittivity characteristics illustrated in FIG. 4 and the permeability characteristics illustrated in FIG. 5, which are the characteristics of the SRR. Adjustment conditions of the configuration for obtaining a wavelength shortening effect around a desired frequency band in the antenna device 200 having such characteristics will be described below.

An inverted-L antenna at a frequency at which the length thereof is close to one quarter of the wavelength on a free space. Therefore, when an inverted-L element conductor is formed on a dielectric, the wavelength shortening effect is affected by a material constant of the dielectric.

In the antenna device 200 illustrated in FIG. 2, the first SRR 201 and the second SRR 202 are disposed between the inverted-L element conductor 204 formed on the dielectric 203 and the ground conductor 206, such that a large wavelength shortening effect can be achieved by multiplying the material constant of the dielectric by the variation of effective permeability around the resonant frequency of the SRR.

In general, a phase speed Vp is expressed by Equation 2.

$${V}_{P} = \frac{C}{\sqrt{ɛγμγ}} \qquad [ Eqn . 2 ]$$

In Equation 2, c denotes the velocity of light in a vacuum state, μγ denotes specific permeability of a medium, and ∈γ denotes relative permittivity of the medium. That is, since a wavelength shortening effect is obtained according to the material constant as expressed by Equation 3, it is possible to obtain a wavelength shortening effect by multiplying the material constant of the dielectric by the variation of the effective permeability around the resonant frequency of the SRR.

$$\frac{1}{\sqrt{ɛγμγ}} \qquad [ Eqn . 3 ]$$

Consequently, according to the antenna configuration illustrated in FIG. 2, the lengths of the conductors of the first SRR 201 and the second SRR 202 are adjusted, such that the antenna resonates around the frequency band of an LTE and the effective permeability significantly changes around the frequency. LTE is one of high speed data communication specifications for a cell phone, called “Long Term Evolution” in 3GPP, which is a standardization body that supports WCDMA (a 3rd cell phone scheme) and indicates a next generation communication system that is being standardized. For example, LTE uses a frequency of 700 MHz.

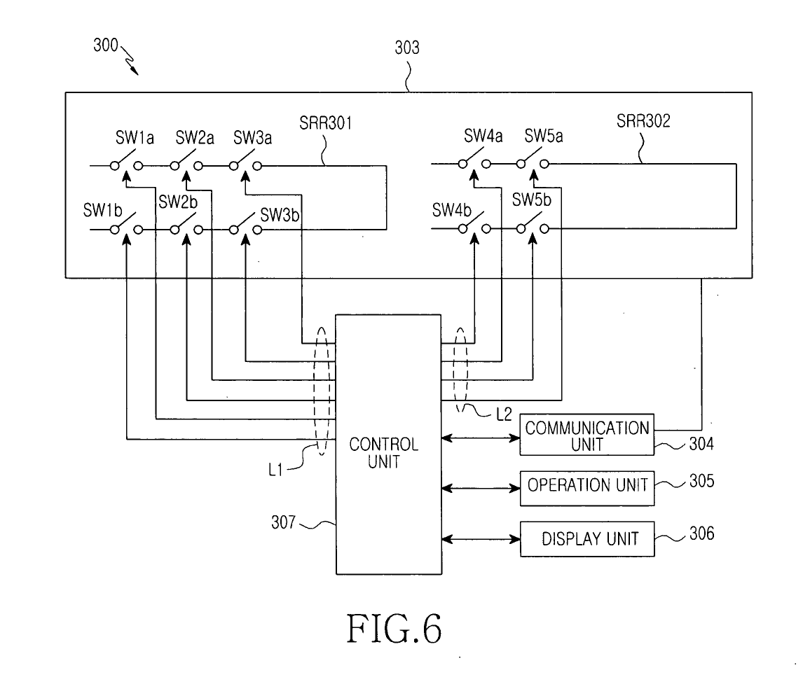

Next, the circuit configuration of a wireless communication apparatus provided with an antenna device with the above-described characteristics in accordance with the embodiment of the present invention will be described with reference to FIG. 6. FIG. 6 illustrates a block diagram of the circuit configuration of the wireless communication apparatus 300 provided with the antenna device 303.

The wireless communication apparatus 300 in accordance with the embodiment of the present invention includes the antenna device 303 that includes a first SRR 301 and a second SRR 302, a communication unit 304, an operation unit 305, a display unit 306, and a control unit 307.

The communication unit 304 transmits/receives various control signals and data signals to/from an external communication system or a base station (not shown) through the antenna device 303 under the control of the control unit 307, and simultaneously outputs received information to the control unit 307. The control unit 307 includes a CPU, a ROM, a RAM, an interface, through which signals are input/output to/from the communication unit 304, the operation unit 305 and the display unit 306, and such, and controls the entire operation of the wireless communication apparatus 300 based on control programs stored in the ROM. For example, the control unit 307 receives signals from the operation unit 305, displays a predetermined image on the display unit 306, and transmits/received data to/from the communication unit 304.

Furthermore, the control unit 307 detects a frequency of a wireless communication signal received in the communication unit 304 and controls the ON/OFF operations of a plurality of switches disposed in the first SRR 301 and the second SRR 302 according to the detected frequency. The plurality of switches are connected to the control unit 307 through a plurality of lines L1 and L2 and perform the ON/OFF operations according to a control signal of the control unit 307. In the embodiment, the control unit 307 controls the ON/OFF operations of the plurality of switches disposed in the first SRR 301 when the frequency of the wireless communication signal corresponding to the LTE is detected and controls the ON/OFF operations of the plurality of switches disposed in the second SRR 302 when the frequency of the wireless communication signal corresponding to a GSM (Global System for Mobile Communication) is detected, thereby adjusting VSWR (Voltage Standing Wave Ratio) frequency characteristics of the antenna 303, which will be described later, to frequency characteristics corresponding to the LTE or the GSM. The GSM is one of the wireless communication schemes used for a cell phone, and uses a frequency band of 850 MHz, 900 MHz and such.

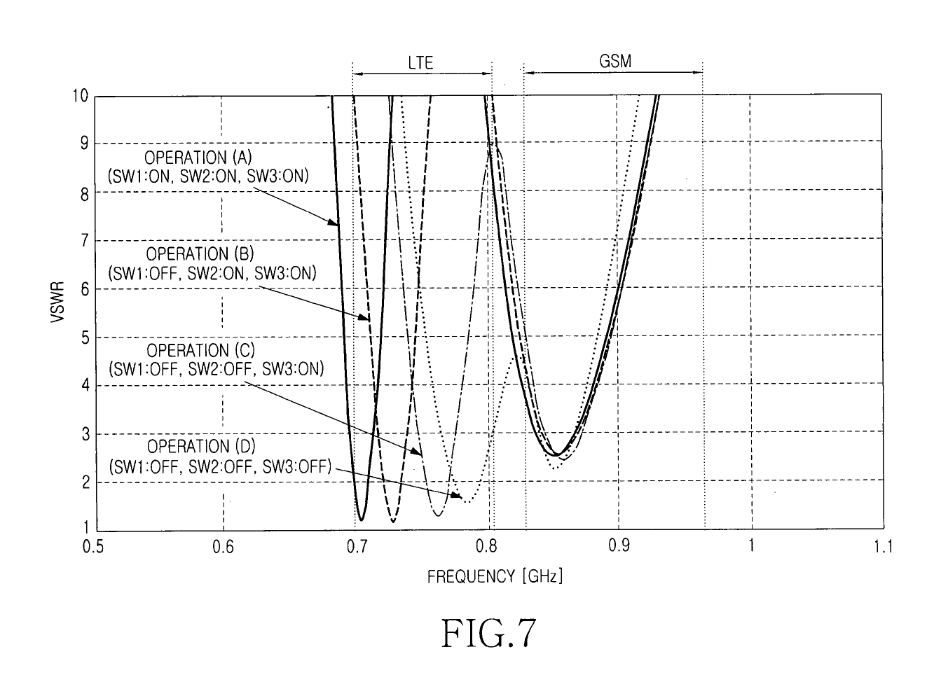

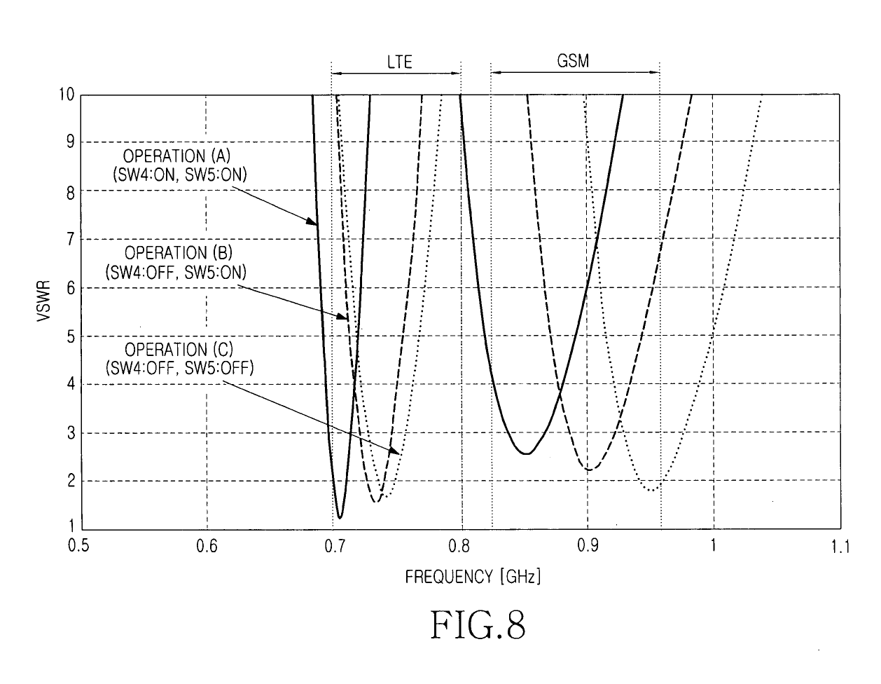

Next, the operation of the antenna device 303 in the wireless communication apparatus 300 illustrated in FIG. 6 will be described with reference to FIGS. 7 and 8. FIG. 7 is a diagram illustrating VSWR characteristics when the antenna device 303 operates in a frequency band corresponding to LTE, and FIG. 8 is a diagram illustrating VSWR characteristics when the antenna device 303 operates in a frequency band corresponding to GSM.

First, the operation of the antenna device 303 in LTE frequency band will be described with reference to FIG. 7. Operations A to D illustrated in FIG. 7 are operations of the switches disposed in the first SRR 301. Furthermore, it is assumed that all switches disposed in the second SRR 302 are turned on when the switches disposed in the first SRR 301 operate.

Operation A illustrated in FIG. 7 is an operation when all switches SW1a, SW1b, SW2a, SW2b, SW3a and SW3b disposed on the conductor of the first SRR 301 are turned on. At this time, the length of the conductor of the first SRR 301 is the longest. Referring to the graph illustrated in FIG. 7, in Operation A, the resonant frequency band of the antenna device 303 is set to the lowest frequency side as compared with the operations B to D.

Operation B illustrated in FIG. 7 is an operation when the switches SW1a and SW1b disposed on the conductor of the first SRR 301 are turned off and the switches SW2a, SW2b, SW3a and SW3b are turned on. At this time, the length of the conductor of the first SRR 301 is shorter than that of the operation A. Referring to the graph illustrated in FIG. 7, in Operation B, the resonant frequency band of the antenna device 303 is shifted to a higher frequency as compared with Operation A.

Operation C illustrated in FIG. 7 is an operation when the switches SW1a, SW1b, SW2a and SW2b disposed on the conductor of the first SRR 301 are turned off and the switches SW3a and SW3b are turned on. At this time, the length of the conductor of the first SRR 301 is shorter than that of Operations A and B. Referring to the graph illustrated in FIG. 7, Operation C, the resonant frequency band of the antenna device 303 is shifted to a higher frequency side as compared with Operation B.

Operation D illustrated in FIG. 7 is an operation when all switches SW1a, SW1b, SW2a, SW2b, SW3a and SW3b disposed on the conductor of the first SRR 301 are turned off. At this time, the length of the conductor of the first SRR 301 is the shortest. Referring to the graph illustrated in FIG. 7, in Operation D, the resonant frequency band of the antenna device 303 is shifted to the highest frequency side as compared with Operations A to C.

Through the operation of the switches illustrated in Operations A to D, the length of the first SRR 301 is gradually shortened to reduce an inductance component, such that the resonant frequency band of the antenna device 303 can be changed to a high frequency side from a low frequency side in the LTE frequency band.

The operation of the antenna device 303 in the GSM frequency band will now be described with reference to FIG. 8. Operations E to G illustrated in FIG. 8 are operations of the switches disposed in the second SRR 302. Furthermore, it is assumed that all switches disposed in the first SRR 301 are turned on when the switches disposed in the second SRR 302 operate.

Operation E illustrated in FIG. 8 is an operation when all switches SW4a, SW4b, SW5a and SW5b disposed on the conductor of the second SRR 302 are turned off. At this time, the length of the conductor of the second SRR 302 is the shortest. Referring to the graph illustrated in FIG. 8, in Operation E, the resonant frequency band of the antenna device 303 is set to the highest frequency side as compared with Operations F and G.

Operation F illustrated in FIG. 8 is an operation when the switches SW4a and SW4b disposed on the conductor of the second SRR 302 are turned off and the switches SW5a and SW5b are turned on. At this time, the length of the conductor of the second SRR 302 is longer than that of Operation E. Referring to the graph illustrated in FIG. 8, in Operation F, the resonant frequency band of the antenna device 303 is shifted to a low frequency side as compared with Operation E.

Operation G illustrated in FIG. 8 is an operation when all switches SW4a, SW4b, SW5a and SW5b disposed on the conductor of the second SRR 302 are turned on. At this time, the length of the conductor of the second SRR 302 is the longest. Referring to the graph illustrated in FIG. 8, in Operation G, the resonant frequency band of the antenna device 303 is shifted to the lowest frequency side as compared with Operations E and F.

Through the operation of the switches illustrated in Operations E to G, the length of the second SRR 302 is gradually lengthened to increase an inductance component, such that the resonant frequency band of the antenna device 303 can be changed to a low frequency side from a high frequency side in the GSM frequency band.

Consequently, the ON/OFF operations of the switches disposed on the conductor of the first SRR 301 are simply switched, such that the VSWR characteristics can be easily changed in the LTE frequency band. Furthermore, the ON/OFF operations of the switches disposed on the conductor of the second SRR 302 are simply switched, such that the VSWR characteristics can be easily changed in the GSM frequency band. As a result, it is possible to adjust the resonant frequency in an independent desired frequency band in the first SRR 301 and the second SRR 302, which are formed on one surface and the other surface of the dielectric.

According to the embodiment of the present invention as described above, the switches are disposed on the conductor of the SRR and, as the ON/OFF of the switches are switched, the resonant frequency can be changed in a desired frequency band. Furthermore, because the switches are disposed on the conductor of the SRR and the ON/OFF of the switches are switched, even if the number of frequency bands of a wireless communication system increases, the structure of the antenna device is not increased and a small-sized wireless communication apparatus applicable to a plurality of wireless communication systems can be provided.

In addition, the operation of the wireless communication apparatus 300 of the embodiment has been described, in which the ON/OFF operations of the switches disposed in the first SRR 301 and the second SRR 302 are switched, such that the resonant frequency is changed in the LTE frequency band or the GSM frequency band. By using the operation for changing the resonant frequency, the wireless communication apparatus 300 can also perform an auto-tuning operation. For example, in an initial state, all switches disposed in the first SRR 301 and the second SRR 302 are turned on or off. The control unit 307 switches the ON/OFF operations of the switches to gradually change the lengths of the conductors of the first SRR 301 and the second SRR 302, such that the resonant frequency is gradually shifted to a low frequency side or a high frequency side, resulting in the automatic tuning to a wireless communication signal.

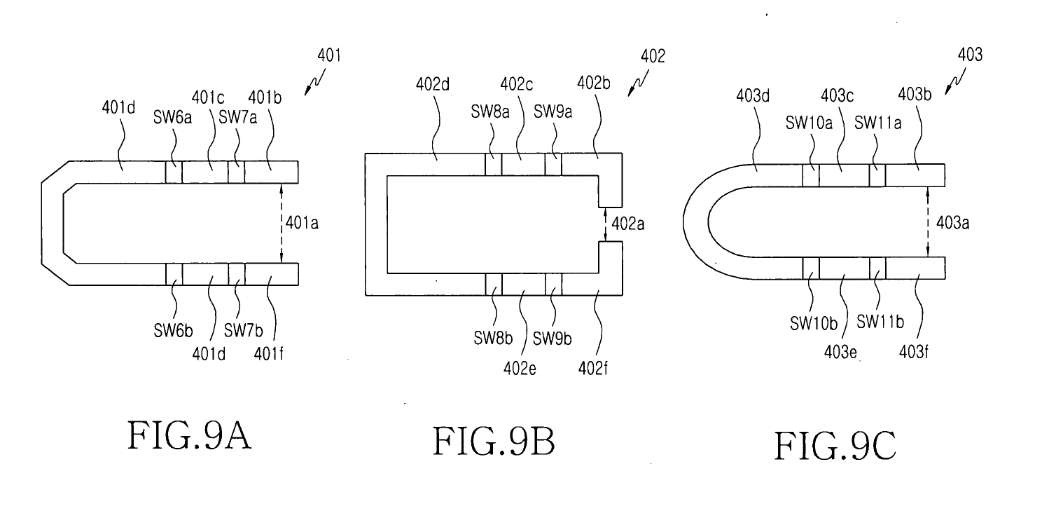

Next, other shapes of the SRR of the antenna device in accordance with the embodiment of the present invention will be described with reference to FIGS. 9A to 9C. FIG. 9A illustrates a plan view of the shape of a SRR 401 that includes an opening 401a formed by removing a part of a polygonal shape, FIG. 9B illustrates a plan view of the shape of a SRR 402 that includes an opening 402a formed by removing a part of a rectangular shape, and FIG. 9C illustrates a plan view of the shape of a SRR 403 that includes an opening 403a formed by removing a part of a ring shape. The present invention is not limited to the above shapes and may be applied to if any shape that can realize the characteristics of the SRR as described above. Furthermore, as illustrated in FIG. 9A, the SRR 401 includes a plurality of members 401b to 401f, a switch SW7a is disposed between the members 401b and 401c, a switch SW6a is disposed between the members 401c and 401d, a switch SW6b is disposed between the members 401d and 401e, and a switch SW7b is disposed between the members 401e and 401f. As illustrated in FIG. 9B, the SRR 402 includes a plurality of members 402b to 402f, a switch SW9a is disposed between the members 402b and 402c, a switch SW8a is disposed between the members 402c and 402d, a switch SW8b is disposed between the members 402d and 402e, and a switch SW9b is disposed between the members 402e and 402f. As illustrated in FIG. 9C, the SRR 403 includes a plurality of members 403b to 403f, a switch SW11a is disposed between the members 403b and 403c, a switch SW10a is disposed between the members 403c and 403d, a switch SW10b is disposed between the members 403d and 403e, and a switch SW11b is disposed between the members 403e and 403f. In this way, similarly to the antenna device 303 illustrated in FIG. 6, the SRRs 401 to 403 illustrated in FIG. 9 are used for the antenna device, resulting in a change in the resonant frequency. Furthermore, the number and positions of switches disposed may be appropriately changed according to the specifications thereof.

In addition, because the antenna device 200, illustrated in FIG. 2 in accordance with the embodiment of the present invention, can be realized by forming the first SRR 201 and the second SRR 202 on the front surface and the rear surface of the dielectric 203 located between the inverted-L element conductor 204 and the ground conductor 206, the antenna device 200 can be manufactured in a simple manner. For example, the first SRR 201 and the second SRR 202 may be formed by etching the front surface and the rear surface of the dielectric 203, or the first SRR 201 and the second SRR 202 may be simply bonded to the front surface and the rear surface of the dielectric 203. Through such a simple manufacturing method, because it is possible to easily adapt with the situation in which a design is changed to allow the antenna device 200 to operate in a desired frequency band, the manufacturing cost can be reduced.

Moreover, the dielectric 203 in accordance with the embodiment of the present invention may be formed of a flexible dielectric film and the like. When the dielectric 203 is manufactured using a flexible dielectric film substrate, because the dielectric 203 can be bent, the dielectric 203 can be easily mounted in a wireless communication apparatus. Furthermore, in addition to the dielectric 203, the element conductor 204 or the ground conductor 206 may be formed using a flexible material.

In accordance with the embodiment of the present invention as described above, the SRRs are disposed on the front surface and the rear surface of the dielectric located between the inverted-L element conductor and the ground conductor, the switches are disposed on the conductors of the SRRs, and the ON/OFF operations of the switches are switched, such that the resonant frequency can be changed in a desired frequency band. In addition, even if the number of frequency bands of a wireless communication system used increases, the structure of the antenna device is not increased and a small-sized wireless communication apparatus applicable to a plurality of wireless communication systems can be provided.

Hereinafter, an antenna device operating in a wide band in accordance with an embodiment of the present invention will be described with reference to the accompanying drawings.

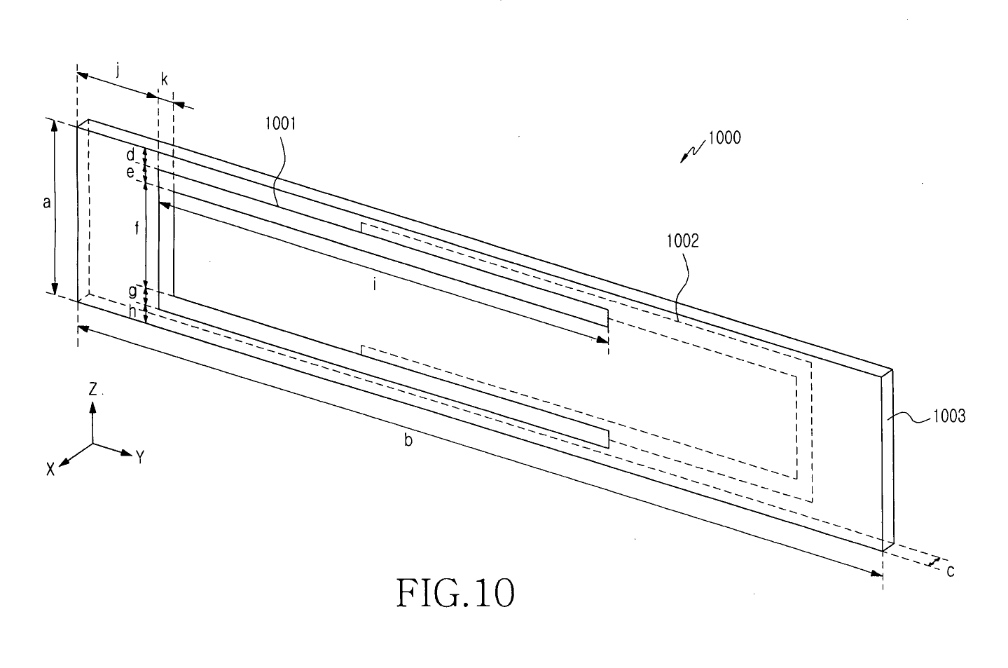

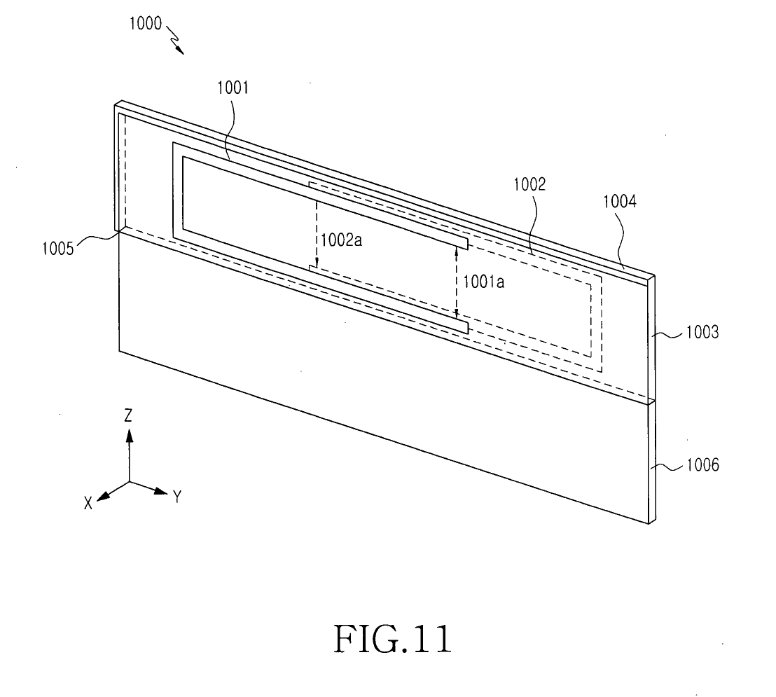

FIG. 10 illustrates a perspective view of the configuration of main elements of the antenna device 1000 in accordance with an embodiment of the present invention. FIG. 11 is a perspective view illustrating the entire configuration of the antenna device illustrated in FIG. 10. A dielectric 1003 in the antenna device 1000 has a rectangular thin plate shape, and a first SRR 1001 and a second SRR 1002 are disposed on the front surface and the rear surface of the dielectric. As illustrated in FIG. 10, the first SRR 1001 and the second SRR 1002 have a first opening 1001a and a second opening 1002a, which are formed by removing one side of a rectangle, respectively. The first SRR 1001 and the second SRR 1002 have the same shape and are disposed at opposite sides with the dielectric 103 interposed between them while they are misaligned from each other.

In accordance with an embodiment of the present invention, as illustrated in FIG. 10, the dielectric 1003 may have a vertical length a of 10 mm in the Z direction, a horizontal length b of 50 mm in the Y direction, and a length c of 1 mm in the X direction corresponding to the thickness of the dielectric 1003 having the thin plate shape. The first SRR 1001 formed on the dielectric 1003 may have a substantially ‘C’ shape including three lines with the same widths (k=e=g). Furthermore, the first SRR 1001 may have a horizontal length i of 28 mm in the Y direction and a vertical length (e+f+g) of 8 mm in the Z direction. In addition, the lengths k, e, and g corresponding to widths of the sides of the three lines may be 1 mm, respectively. Moreover, in relation to the installation position of the first SRR 1001 on the dielectric 1003, the distance j from a short side with the vertical length a in the Z direction of the dielectric 1003 to one side with the vertical length (e+f+g) in the Z direction of the first SRR 1001 may be 5 mm, and the distances d and h from a long side with the horizontal length b in the Y direction of the dielectric 1003 to two sides with the horizontal length i in the Y direction of the first SRR 1001 may be 1 mm, respectively. Furthermore, the shape of the second SRR 1002 is the same as that of the first SRR 1001 and the installation position of the second SRR 1002 on the dielectric 1003 is the same as that of the first SRR 1001. However, the dimensions of each element may be appropriately changed according to the specifications thereof in the embodiment of the present invention.

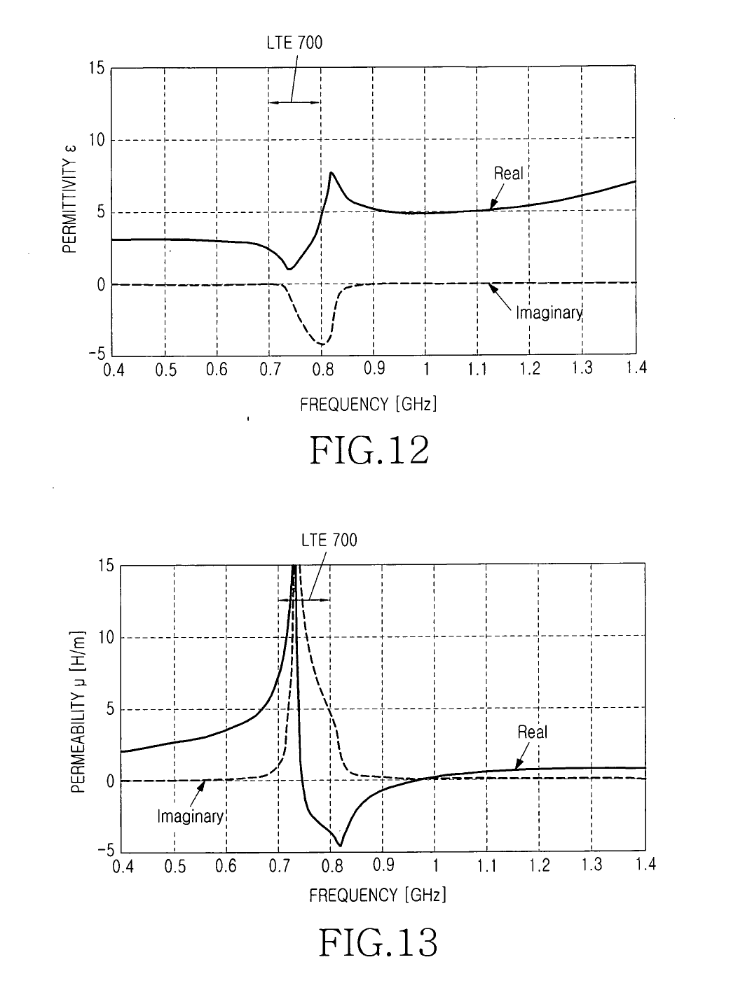

Next, the characteristics of the antenna device in accordance with an embodiment of the present invention will be described with reference to FIGS. 12 and 13. FIG. 12 illustrates permittivity characteristics of the antenna device 1000 illustrated in FIG. 10, and FIG. 13 illustrates permeability characteristics of the antenna device 1000 illustrated in FIG. 10. FIGS. 12 and 13 illustrate characteristics of real parts and imaginary parts of permittivity and permeability, respectively. The general characteristics of the SRR regarding such characteristics are the same as those described in the previous embodiment.

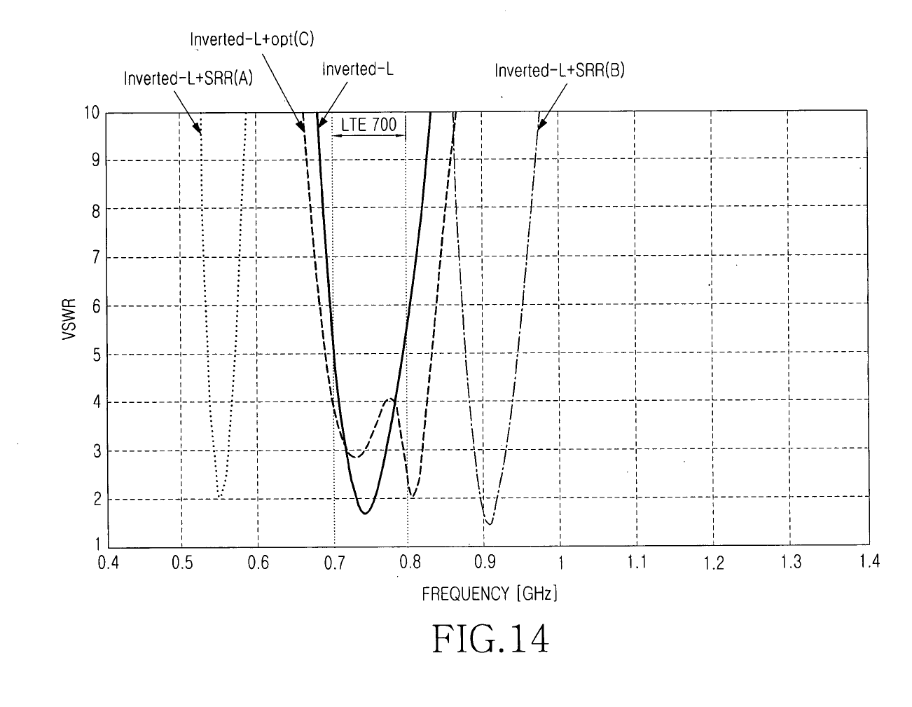

Next, the VSWR frequency characteristics of the antenna device 1000 will be described with reference to FIG. 14. FIG. 14 illustrates the VSWR characteristics obtained by a combination of the first and second SRRs 1001 and 1002 in the antenna device 1000 and an element conductor 1004. The graph indicated by “Inverted-L+SRR(A)” and “Inverted-L+SRR(B)” in FIG. 14 illustrate the VSWR characteristics obtained by the combination of the first and second SRRs 1001 and 1002 and an element conductor 1004. Furthermore, in FIG. 14, the VSWR characteristics when only an inverted-L antenna is provided are indicated by “Inverted-L”.

Referring to the graph of the “Inverted-L+SRR(A)” in FIG. 14, it can be understood that the resonant frequency is reduced as compared with the graph of the “Inverted-L”. This is caused by a variation in material characteristics around the resonant frequency of the SRR, and a wavelength shortening effect obtained by multiplying the material constant of the dielectric by the variation in the effective permeability around the resonant frequency of the SRR, which is larger than the wavelength shortening effect due to the material constant. Consequently, the two SRRs are disposed on the front surface and the rear surface of the dielectric, such that the resonant frequency can be reduced as illustrated in the “Inverted-L+SRR(A)”, and the antenna device 1000 can be fabricated in a small size.

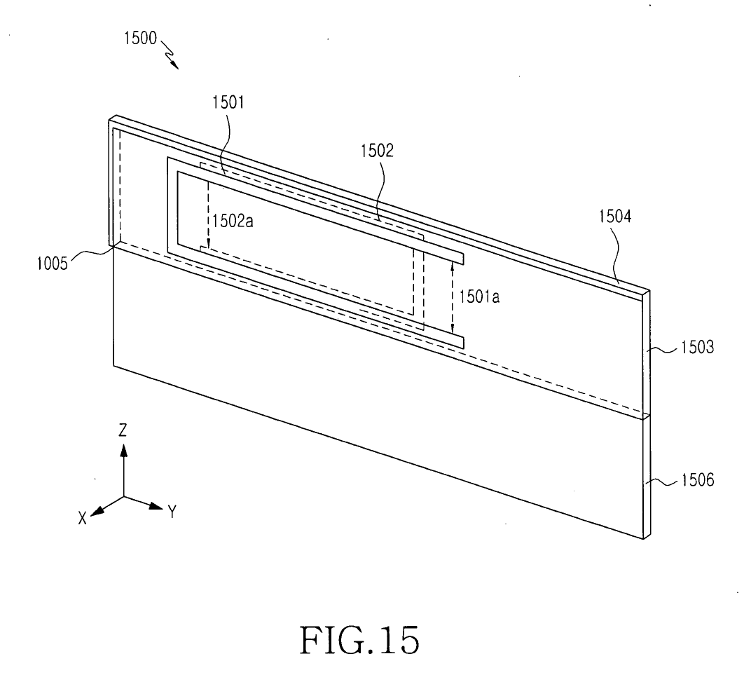

Next, adjustment conditions of the configuration for enabling an operation in a wide band around a desired frequency band in the antenna device will be described below. The VSWR characteristics of the antenna device when the lengths of the conductors of the first SRR 1001 and the second SRR 1002 illustrated in FIG. 11 are changed to different lengths will be described with reference to FIGS. 14 and 15.

FIG. 15 illustrates an entire configuration example of an antenna device 1500 provided with a first SRR 1501 and a second SRR 1502 which are adjusted to operate in a desired frequency band. The antenna device 1500 illustrated in FIG. 15 includes the first SRR 1501, the second SRR 1502, a dielectric 1503, an element conductor 1504, a power supply point 1505, and a ground conductor 1506. As illustrated in FIG. 15, the first SRR 1501 and the second SRR 1502 have a first opening 1501a and a second opening 1502a, which each are formed by removing one side of a rectangle and have three sides, respectively. The lengths of two sides in the Y direction of the first SRR 1501 are longer than those of two sides in the Y direction of the second SRR 1502. Furthermore, the antenna device 1500 is substantially identical to that of the antenna device 1000 illustrated in FIGS. 3A and 3B, except that the lengths in the Y direction of the first SRR 1501 are different from those in the Y direction of the second SRR 1502.

Referring to FIG. 14, the VSWR characteristics obtained by a combination of the first and second SRRs 1501 and 1502 and the element conductor 1504, which are illustrated in FIG. 15, are indicated by “Inverted-L+SRR opt(C)”.

The first SRR 1501 illustrated in FIG. 15 has a length extending in the Y direction, as compared with the first SRR 1001 illustrated in FIG. 11, such that the resonant frequency indicated by “Inverted-L+SRR(B)” in the graph of FIG. 14 is shifted from a high frequency side to a low frequency side. Meanwhile, the second SRR 1502 illustrated in FIG. 15 has a length in the Y direction, which is shorter than that of the second SRR 1002 illustrated in FIG. 11, such that the resonant frequency indicated by “Inverted-L+SRR(A)” in the graph of FIG. 14 is shifted from the low frequency side to the high frequency side. Furthermore, the length in the Y direction of the element conductor 1504 is shortened, such that the resonant frequency indicated by “Inverted-L+SRR(A)” in the graph of FIG. 14 is shifted from the low frequency side to the high frequency side. Thus, because the length in the Y direction of the first SRR 1501 is allowed to be longer than the length in the Y direction of the second SRR 1002, the graph indicated by “Inverted-L+SRR(A)” is shifted to the high frequency side and the graph indicated by “Inverted-L+SRR(B)” is shifted to the low frequency side, resulting in the synthesis with the graph indicated by “Inverted-L+SRR opt(C)”. Consequently, the lengths of the conductors of the first and second SRRs 1501 and 1502 and the length of the element conductor 1504 are adjusted, resulting in the resonance around a desired frequency band. For example, because two-resonance can be achieved around a frequency band of LTE 700 as with the resonant frequency indicated by “Inverted-L+SRR opt(C)” of FIG. 14, an operation in a wideband can be performed.

Furthermore, because the antenna device 1000 in accordance with the embodiment of the present invention can be realized by forming the first SRR 1001 and the second SRR 1002 on the front surface and the rear surface of the dielectric 1003 located between the inverted-L element conductor 1004 and the ground conductor 1006, the antenna device 1000 can be manufactured in a simple manner. For example, the first SRR 1001 and the second SRR 1002 may be formed by etching the front surface and the rear surface of the dielectric 1003, or the first SRR 1001 and the second SRR 1002 may be simply bonded to the front surface and the rear surface of the dielectric 1003. In addition, because the antenna device 1500 in accordance with the embodiment of the present invention can be realized by forming the first SRR 1501 and the second SRR 1502 on the front surface and the rear surface of the dielectric 1503 located between the inverted-L element conductor 1504 and the ground conductor 1506, the antenna device 1500 can be manufactured in a simple manner. For example, the first SRR 1501 and the second SRR 1502 may be formed by etching the front surface and the rear surface of the dielectric 1503, or the first SRR 1501 and the second SRR 1502 may be simply bonded to the front surface and the rear surface of the dielectric 1503. Because it is possible to easily adapt with the situation in which a design is changed to allow the antenna devices 1000 and 1500 to operate in a desired frequency band, the manufacturing cost can be reduced.

Moreover, the dielectrics 1003 and 1503 in accordance with an embodiment of the present invention may be formed of a flexible dielectric film and such. When the dielectrics 1003 and 1503 are manufactured using a flexible dielectric film substrate, because the dielectrics 1003 and 1503 can be bent, the dielectrics 1003 and 1503 can be easily mounted in a wireless communication apparatus. Furthermore, in addition to the dielectrics 1003 and 1503, the element conductors 1004 and 1504 or the ground conductors 1006 and 1506 may be formed using a flexible material.

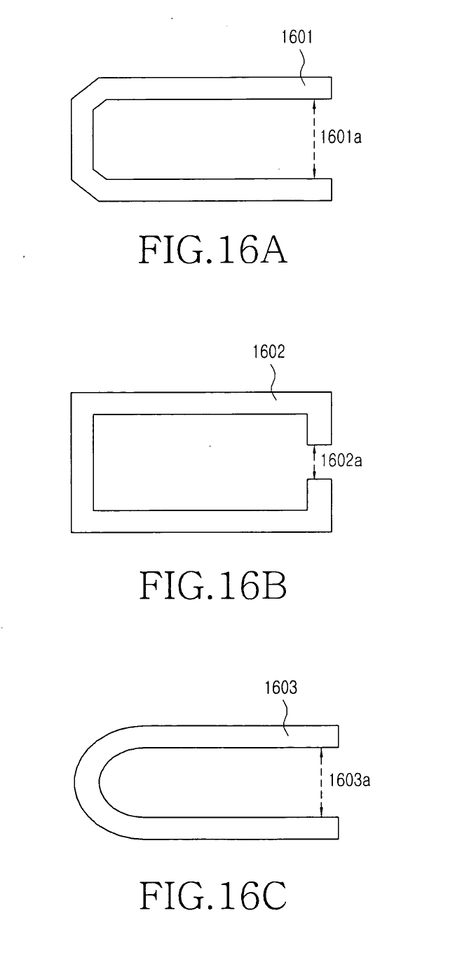

FIGS. 16A to 16C illustrate plan views of other shapes of a SRR of the antenna device in accordance with an embodiment of the present invention. FIG. 16A illustrates the shape of a SRR 1601 that includes an opening 1601a formed by removing a part of a polygonal shape, FIG. 16B is a diagram illustrating the shape of a SRR 1602 that includes an opening 1602a formed by removing a part of a rectangular shape, and FIG. 16C is a diagram illustrating the shape of a SRR 1603 that includes an opening 1603a formed by removing a part of a ring shape. The present invention is not limited to the above shapes and includes any shape that can realize the characteristics of the SRR as described above.

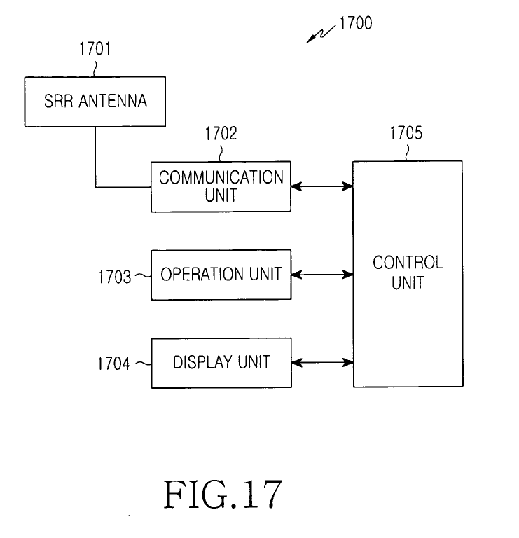

FIG. 17 illustrates a block diagram of the configuration of a wireless communication apparatus provided with an antenna device in accordance with an embodiment of the present invention. The wireless communication apparatus 1700 in accordance with an embodiment of the present invention includes the antenna device 1701 that includes a SRR, a communication unit 1702, an operation unit 1703, a display unit 1704, and a control unit 1705.

The communication unit 1702 transmits/receives various control signals and data signals to/from an external communication system or a base station (not shown) through the antenna device 1701 under the control of the control unit 1705, and simultaneously outputs received information to the control unit 1705. The control unit 1705 includes a CPU, a ROM, a RAM, an interface, through which signals are input/output to/from the communication unit 1702, the operation unit 1703 and the display unit 1704, and such, and controls the entire operation of the wireless communication apparatus 1700 based on control programs stored in the ROM. For example, the control unit 1705 receives signals from the operation unit 1703, displays a predetermined image on the display unit 1704, and transmits/received data to/from the communication unit 1702. Because the wireless communication apparatus 1700 uses the antenna device 1701 that includes the SRR, the wireless communication apparatus 1700 can be easily applied to a next generation communication system, such as LTE 700, through a design modification thereof, and can be fabricated in a small size.

In accordance with the embodiments of the present invention as described above, the SRRs are disposed on the front surface and the rear surface of the dielectric located between the inverted-L conductor and the ground conductor, resulting in the achievement of a wavelength shortening effect which is larger than a wavelength shortening effect due to the material constant. Furthermore, because the resonant frequency of the inverted-L antenna can be shifted to a low frequency side, the antenna can be fabricated in a small size.

In addition, both the lengths of the inverted-L shaped element conductor and the conductor of the SRR are modified, resulting in the achievement of wide band characteristics by which an operation in a desired frequency band is possible.

The antenna device in accordance with the embodiments of the present invention may be applied to antenna devices used for various mobile information terminals including cell phones, personal computers, and any electronic device capable of wireless communication.

According to an antenna device and a wireless communication apparatus that includes an antenna device in accordance with an embodiment of the present invention, even if the number of frequency bands used increases, the antenna device can be fabricated in a small size without the increase in the structure thereof and a resonant frequency can be easily changed in a desired frequency band.

Furthermore, according to an antenna device and a wireless communication apparatus that includes an antenna device in accordance with an embodiment of the present invention, a wavelength shortening effect, which is larger than a wavelength shortening effect due to the material constant, can be achieved and a resonant frequency can be shifted to a low frequency side, such that the antenna device and the wireless communication apparatus that includes an antenna device can be fabricated in a small size. In addition, parameters (the length of a conductive member, the size of an opening, a relative position and the like) regarding the conductive member constituting the antenna device may be adjusted, such that an operation in a desired frequency band is possible. Consequently, it is possible to provide the antenna device and the wireless communication apparatus that includes an antenna device, which can easily achieve wide band characteristics.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An antenna device comprising:
a dielectric comprising a first and a second substantially planar surfaces facing in substantially opposite directions;
an inverted-L antenna disposed at a side of the dielectric;
a first conductive member forming a first loop comprising a first gap, a planar side of the first loop disposed facing the first substantially planar surface of the dielectric; and
a second conductive member forming a second loop comprising a second gap, a planar side of the second loop disposed facing the second substantially planar surface of the dielectric,
wherein the each of the first and second conductive members comprises a plurality of member components and a plurality of switches, and each of the plurality of switches provided between two adjacent member components to allow the plurality of member components to be electrically conducted or cut off.

2. The antenna device according to claim 1, wherein each of the first and second gaps forms an opening in the first and second loops of the first and second conductive members, respectively, a length of each of the first and second conductive members forms an inductance component, a size of the opening forms a capacitance component, the first and second conductive members form an LC resonance circuit including the inductance component and the capacitance component, and the plurality of switches allow the plurality of member components to be electrically conducted or cut off through an ON/OFF operation to change a number of connections, through which the plurality of member components are connected to each other, for each conductive member, resulting in a change in the inductance component of the first and second of conductive members.

3. The antenna device according to claim 2, further comprising a control unit that controls the ON/OFF operation of each switch according to a wireless communication frequency band used to change the inductance component of the first and second conductive members, detects a frequency of a wireless communication signal, and controls the ON/OFF operation of each switch according to the detected frequency.

4. The antenna device according to claim 1, wherein the plurality of switches allow the plurality of member components to be electrically conducted or cut off.

5. The antenna device according to claim 1, wherein the first conductive member is bonded to the first substantially planar surface, and the second conductive member is bonded to the second substantially planar surface of the dielectric.

6. The antenna device according to claim 1, wherein the first and second conductive members are formed on the first and second surfaces of the dielectric, respectively, by using an etching method.

7. The antenna device according to claim 1, wherein the dielectric has a thin plate shape.

8. A wireless communication apparatus comprising:
an antenna device that comprises:
a dielectric comprising a first and a second substantially planar surfaces facing in substantially opposite directions,
an inverted-L antenna disposed at a side of the dielectric,
a first conductive member forming a first loop comprising a first gap, a planar side of the first loop disposed facing the first substantially planar surface of the dielectric, and
a second conductive member forming a second loop comprising a second gap, a planar side of the second loop disposed facing the second substantially planar surface of the dielectric,
wherein the each of the first and second conductive members comprises a plurality of member components and a plurality of switches, and each of the plurality of switches area provided between two adjacent member components to allow the plurality of member components to be electrically conducted or cut off.

9. The wireless communication apparatus of claim 8, wherein each of the first and second gaps forms an opening in the first and second loops of the first and second conductive members, respectively, a length of each of the first and second conductive members forms an inductance component, a size of the opening forms a capacitance component, the first and second conductive members form an LC resonance circuit including the inductance component and the capacitance component, and the plurality of switches allow the plurality of member components to be electrically conducted or cut off through an ON/OFF operation to change a number of connections, through which the plurality of member components are connected to each other, for each conductive member, resulting in a change in the inductance component of the first and second of conductive members.

10. An antenna device comprising:
a dielectric comprising a first and a second substantially planar surfaces facing in substantially opposite directions;
an inverted-L antenna disposed at a side of the dielectric;
a first conductive member forming a first loop comprising a first gap, a planar side of the first loop disposed facing the first substantially planar surface of the dielectric; and
a second conductive member forming a second loop comprising a second gap, a planar side of the second loop disposed facing the second substantially planar surface of the dielectric.

11. The antenna device according to claim 10, wherein each of the first and second gaps forms an opening in the first and second loops of the first and second conductive members, respectively, a length of each of the first and second conductive members forms an inductance component, a size of the opening forms a capacitance component, the first and second conductive members form an LC resonance circuit including the inductance component and the capacitance component, and at least one of the length of each of the first and second conductive members and the size of the opening is adjusted to control a resonant frequency of the LC resonance circuit.

12. The antenna device according to claim 11, wherein relative positions of the first and second conductive members disposed facing the dielectric are changed to control the capacitance component.

13. The antenna device according to claim 11, wherein a relative distance between the first and second conductive members is changed according to a thickness of the dielectric to control the capacitance component.

14. The antenna device according to claim 11, wherein relative positions of the first and second conductive members disposed facing the dielectric and the inverted-L antenna are changed to control the capacitance'component.

15. The antenna device according to claim 11, wherein a length of each of the first and second conductive members disposed facing the dielectric and a length of the inverted-L antenna are changed to control the inductance component.

16. The antenna device according to claim 10, wherein the first and second conductive members are formed on the first and second surfaces of the dielectric, respectively, by using an etching method.

17. The antenna device according to claim 10, wherein the first and second conductive members are bonded to the first and second surfaces of the dielectric, respectively.

18. The antenna device according to claim 10, wherein the dielectric comprises a thin plate shape.

19. A wireless communication apparatus, comprising:
an antenna device comprising:
a dielectric comprising a first and a second substantially planar surfaces facing in substantially opposite directions;
an inverted-L antenna disposed at a side of the dielectric;
a first conductive member forming a first loop comprising a first gap, a planar side of the first loop disposed facing the first substantially planar surface of the dielectric; and
a second conductive member forming a second loop comprising a second gap, a planar side of the second loop disposed facing the second substantially planar surface of the dielectric.

20. The wireless communication apparatus of claim 19, wherein each of the first and second gaps forms an opening in the first and second loops of the first and second conductive members, respectively, a length of each of the first and second conductive members forms an inductance component, a size of the opening forms a capacitance component, the first and second conductive members form an LC resonance circuit including the inductance component and the capacitance component, and at least one of the length of each of the first and second conductive members and the size of the opening is adjusted to control a resonant frequency of the LC resonance circuit.
